(19) United States
(12) Patent Application Publication
(10) Pub. No.: US 2016/0075603 A1
(43) Pub. Date: Mar. 17, 2016

(54) Binder Compositions and Method of Synthesis

(71) Applicant: Arizona Science and Technology Enterprises, LLC, Scottsdale, AZ (US)

(72) Inventors: Narayanan Neithalath, Chandler, AZ (US); David Stone, Tucson, AZ (US)

(21) Appl. No.: 14/856,399

(22) Filed: Sep. 16, 2015

Related U.S. Application Data
(60) Provisional application No. 62/051,122, filed on Sep. 16, 2014.

(51) Int. Cl. C04B 28/00

(52) U.S. Cl. CPC C04B 28/00

(57) ABSTRACT

Some embodiments of the invention include a method of producing iron carbonate binder compositions including providing a plurality of binder precursors including a powdered iron or steel, a first powdered additive comprising silica, a second powdered additive including calcium carbonate, and a powdered clay. The method includes mixing the plurality of binder precursors and a water additive to form an uncured product, and feeding at least a portion of the uncured product into a curing chamber. The curing chamber is fluidly coupled to a CO₂ source so that some CO₂ from the CO₂ source reacts with the uncured product to form a cured iron carbonate containing product and at least one reaction byproduct, where at least some byproduct can be fed from the curing chamber to the CO₂ source for use as a fuel by the CO₂ source.

### RELATED APPLICATIONS

This application claims priority from Provisional Application No. 62/051,122, filed on Sep. 16, 2014, the entire contents of which are incorporated herein by reference.

### STATEMENT REGARDING FEDERAL SPONSORED RESEARCH OR DEVELOPMENT

Some research conducted for conception and development of at least one embodiment of the invention described herein was made using Federal awarded by the National Science Foundation under Grant No. 1353170. The U.S. Federal Government has certain rights in the invention.

### BACKGROUND

Anthropogenic emission of CO₂ is accepted as being responsible for changes in global climate and potentially irreversible damaging impacts on ecosystems and societies. Various technologies designed to reduce the amount of greenhouse gases such as CO₂ in the atmosphere is an active research area through the developed and developing world. The sequestration of CO₂ offers the potential to prevent CO₂ from entering the atmosphere (i.e., by removal of the CO2 from an industrial waste stream), or a potential route to extraction of CO₂ that is already present in the atmosphere. Physical trapping of CO₂, such as injection of CO₂ into depleted natural gas reservoirs under the seabed or into the deep ocean has not yet been proven to be a leak-proof technology option. Chemical sequestration on the other hand offers the potential to trap the CO₂ virtually permanently. The use of mineral rocks (especially alkaline-earth oxide bearing rocks) as a feedstock for reaction with CO₂ is one of the promising routes for reduction of concentration of CO₂ in the atmosphere. CO₂ is passed through the rock, and chemically sequestered through mineral carbonation. See for example, Klein, E.; Lucia, M. D.; Kempka, T.; Kühn, M. Evaluation of Long-term Mineral Trapping at the Ketzin Pilot Site for CO₂ Storage: An Integrative Approach Using Geochemical Modeling and Reservoir Simulation. Int. J. Greenhouse Gas control 2013, 19, 720-730, and Xu, T.; Apps, J. A.; Pruess, K.; Yamamoto, H. Numerical Modeling of Injection and Mineral Trapping of CO₂ with H2S and SO2 in a Sandstone Formation. Chem. Geol. 2007, 242, 319-346, and Naganuma, T.; Yukimura, K.; Todaka, N.; Ajima, S. Concept and Experimental Study for a New Enhanced Mineral Trapping System by Means of Microbially Mediated Processes. Energy Procedia 2011, 4, 5079-5084.

Many industrial processes produce metal and metal oxide wastes that require disposal. For example, particulate waste that includes some metallic iron or steel powder can be generated in significant amounts as bag-house dust waste during the Electric Arc Furnace (EAF) manufacturing process of steel and from the shot-blasting operations of structural steel sections. The traditional means of disposing EAF and shot-blasting dust is landfilling as it is not economically feasible to recycle the iron from the dust. Several million tons of such waste material is being landfilled at great costs all over the world. It is known that secondary carbonate rocks formed during mineral trapping demonstrate mechanical strength, which suggests the possibility of using mineral trapping in conjunction with a binder for the development of a sustainable construction material.

Several studies on iron carbonate formation by CO₂ corrosion of steel have been reported (see for example, Wu, S. L.; Cui, Z. D.; He, F.; Bai, Z. Q.; Zhu, S. L.; Yang, X. J. Characterization of the Surface Film Formed from Carbon Dioxide Corrosion on N80 Steel. Mater. Lett. 2004, 58, 1076-1081, and Nordsveen, M.; Ne\check{s}ić, S.; Nyborg, R.; Stangeland, A. A Mechanistic Model for Carbon Dioxide Corrosion of Mild Steel in the Presence of Protective Iron Carbonate Films—Part 1: Theory and Verification. Corros. Sci. 2003, 59, 443-456, and Nesic, S.; Postlethwaite, J.; Olsen, S. An Electrochemical Model for Prediction of Corrosion of Mild Steel in Aqueous Carbon Dioxide Solutions. Corros. Sci. 1996, 52, 280-294, and Sun, J. B.; Zhang, G. A.; Liu, W.; Lu, M. X. The Formation Mechanism of Corrosion Scale and Electrochemical Characteristic of Low Alloy Steel in Carbon Dioxide-saturated Solution. Corros. Sci. 2012, 57, 131-138. In addition to iron oxidation, dissolved CO₂ is also capable of reacting with iron. A dense layer of iron carbonate can form which adheres strongly to the substrate. For example, CO₂ can react with iron as outlined in the following reaction equations (1), (2):

Fe+2CO₂+2H₂O→Fe²⁺+2HCO₃⁻+H₂↑ (1)

Fe²⁺+2HCO₃⁻→FeCO₃+CO₂+H₂O (2)

The net reaction then can be defined by the following reaction equation (3):

Fe+CO₂+H₂O→FeCO₃+H₂↑ (3)

However the kinetics of the reaction and the rate of product formation are often very slow. To be of any use for beneficial industrial applications, a promoter including one or more reducing agents can be added to increase the rate of reaction. However the handling and processing properties of the mixtures of powders can prevent optimal mixing of materials, thereby preventing homogeneous reaction and compositional development.

### SUMMARY OF THE INVENTION

Some embodiments of the invention include a method of producing iron carbonate binder compositions comprising providing a plurality of binder precursors including a powdered iron or steel, a first powdered additive comprising silica, a second powdered additive comprising calcium carbonate, and a powdered clay. The method includes providing a curing chamber including a first fluid coupling between a first end of the curing chamber and a first end of a CO₂ source, and a second fluid coupling between a second end of the curing chamber and a second end of the CO₂ source. The method further includes mixing the plurality of binder precursors and a water additive to form an uncured product, and feeding at least a portion of the uncured product into a curing chamber. Further, the method includes using CO₂ at least partially from the CO₂ source, curing at least a portion of the uncured product to form a cured iron carbonate containing product and at least one reaction byproduct.

In some embodiments, the first powdered additive further comprises alumina. In some further embodiments, the powdered clay comprises at least one of kaolinite and metakaolin. In some embodiments, the water additive comprises at least one of effluent water and seawater. In some further embodiments of the invention, the plurality of binder precursors includes at least one organic reducing agent comprising at least one carboxylic acid additive. In some other embodiments, the at least one carboxylic acid additive comprises oxalic acid.

Some embodiments include a second powdered additive that comprises limestone. In some further embodiments, the first powdered additive is derived from fly ash. In some embodiments, the powdered iron or steel comprises powdered iron or steel recycled from at least one industrial process.

In some embodiments of the invention, the curing chamber is coupled to or integrated with an existing industrial process comprising the CO₂ source. In some further embodiments, the CO₂ source comprises a furnace of the existing industrial process. In some further embodiments, the CO₂ source comprises at least one of a furnace, a boiler, a reactor or process vessel, a power station or generator, an oil or gas well or field, a natural or synthetic CO₂ aquifer, a CO₂ sequestration apparatus, and the atmosphere or environment.

In some embodiments, the CO₂ from the CO₂ source is fed to the curing chamber by the second fluid coupling. In some embodiments, the flow rate of the CO₂ is determined by at least one meter and is controlled by at least one valve. In some embodiments, the at least one reaction byproduct is fed from the curing chamber to the CO₂ source by the first fluid coupling.

In some embodiments of the invention, at least one reaction byproduct is hydrogen gas. In some further embodiments, the at least one reaction byproduct is CHxOy, where x=0-4 and y=0-2.

In some embodiments, the flow rate of the at least one byproduct is determined by at least one meter and is controlled by at least one valve. In some embodiments, at least some of the carbonate of the iron carbonate containing product is formed from CO₂ from the CO₂ source. In some embodiments, the CO₂ from the CO₂ source is produced by an exothermic reaction driven at least in part by the at least one reaction byproduct.

### DESCRIPTION OF THE DRAWINGS

FIG. 1 illustrates a schematic of a method of synthesis and processing of binder compositions using a recycled reaction products integrated within a conventional furnace process in accordance with some embodiments of the invention.

FIG. 2 provides an illustrative view of a scanning electron micrograph of iron particles according to one embodiment of the invention.

FIG. 3A shows a plot of particle size distribution of metallic iron powder, OPC, fly ash, metakaolin, which is the clay source and limestone powder in accordance with at least one embodiment of the invention.

FIG. 3B illustrates a table of compositions comprising mixtures of iron powder, fly ash, limestone and a clay source such as metakaolin and/or kaolinite in accordance with at least one embodiment of the invention.

FIG. 4A illustrates a plot of compressive strength values of mixtures after 3 days in CO₂ and 2 days in air in accordance with various embodiments of the invention.

FIG. 4B illustrates a plot of compressive strength values of mixtures showing 7-day compressive strengths of plain and modified OPC mixtures for comparison with 4-day carbonated iron-carbonate (mixture 2: 60% iron powder, 20% fly ash, 8% limestone, 10% metakaolin) in accordance with various embodiments of the invention.

FIG. 5A illustrates a plot of the effect of fly ash content on the compressive strength of iron carbonate binders in accordance with some embodiments of the invention.

FIG. 5B illustrates a plot of the effect of limestone content on the compressive strength of iron carbonate binders in accordance with some embodiments of the invention.

FIG. 5C illustrates a plot of the effect of metakaolin content on the compressive strength of iron carbonate binders in accordance with some embodiments of the invention.

FIG. 6A illustrates a response surface plot showing the statistical influence of amounts of fly ash and metakaolin in accordance with some embodiments of the invention.

FIG. 6B illustrates a response surface plot showing the statistical influence of amounts of fly ash and limestone in accordance with some embodiments of the invention.

FIG. 6C illustrates a response surface plot showing the statistical influence of amounts of limestone and metakaolin in accordance with some embodiments of the invention.

FIG. 7 shows a bar graph of the comparison of compressive strength of mixture 1 (comprising 64% iron powder, 20% fly ash, 8% limestone, 6% metakaolin) and mixture 2 (comprising 60% iron powder, 20% fly ash, 8% limestone, 10% metakaolin) under different curing conditions in accordance with some embodiments of the invention.

FIG. 8A illustrates a surface plot of the effect of curing procedure and curing duration in accordance with some embodiments of the invention.

FIG. 8B shows a bar graph of the effect of air-curing duration on compressive strength of mixture 2 (comprising 60% iron powder, 20% fly ash, 8% limestone, 10% metakaolin), and carbonated for 4 days in accordance with some embodiments of the invention.

FIG. 9 illustrates a graph showing variations in average pore diameter with varying carbonation durations for mixture 2 (comprising 60% iron powder, 20% fly ash, 8% limestone, 10% metakaolin) in accordance with some embodiments of the invention.

FIG. 10A illustrates a plot showing a logarithmic increase of flexural strength with increase in carbonation duration, where mixture 1 comprises 64% iron powder, 20% fly ash, 8% limestone, 6% metakaolin, and mixture 2 comprises 60% iron powder, 20% fly ash, 8% limestone, 10% metakaolin in accordance with some embodiments of the invention.

FIG. 10B illustrates a plot showing the interaction between bulk density and flexural strength for the mixtures of FIG. 10A in accordance with some embodiments of the invention.

FIG. 11A shows a plot including thermogravimetric and differential thermogravimetric curves corresponding to the core and surface of mixture 2 (comprising 60% iron powder, 20% fly ash, 8% limestone, 10% metakaolin), carbonated for 3 days in accordance with some embodiments of the invention.

FIG. 11B shows a plot including thermogravimetric and differential thermogravimetric curves corresponding to the core and surface of mixture 6 (comprising 65% iron powder, 15% fly ash, 8% limestone, 10% metakaolin), carbonated for 3 days in accordance with some embodiments of the invention.

FIG. 12A illustrates thermal analysis results of samples from mixture 2 (comprising 60% iron powder, 20% fly ash, 8% limestone, 10% metakaolin) carbonated for 1 day, where samples were exposed to air for 3 days after carbonation in accordance with some embodiments of the invention.

FIG. 12B illustrates thermal analysis results of samples from mixture 2 (comprising 60% iron powder, 20% fly ash, 8% limestone, 10% metakaolin) carbonated for 2 days, where samples were exposed to air for 3 days after carbonation in accordance with some embodiments of the invention.

FIG. 12C illustrates thermal analysis results of samples from mixture 2 (comprising 60% iron powder, 20% fly ash, 8% limestone, 10% metakaolin) carbonated for 3 days, where samples were exposed to air for 3 days after carbonation in accordance with some embodiments of the invention.

FIG. 12D illustrates thermal analysis results of samples from mixture 2 (comprising 60% iron powder, 20% fly ash, 8% limestone, 10% metakaolin) carbonated for 4 days, where samples were exposed to air for 3 days after carbonation in accordance with some embodiments of the invention.

FIG. 13A illustrates a plot of the effect of carbonation duration on mass loss in the 250-400° C. range in thermogravimetric analysis in accordance with some embodiments of the invention.

FIG. 13B illustrates a plot of the effect of carbonation duration on the amount of CaCO₃ remaining in the 250-400° C. range in thermogravimetric analysis in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include various compositions and synthesis methods of a structural binder utilizing the chemistry of iron carbonation. In some embodiments, a structural binder can be formed by reaction of iron with carbon dioxide (herein referred to as CO₂). In some embodiments, the CO₂ can be waste CO₂ obtained from one or more industrial processes. Some embodiments include methods to form a sustainable binder system for concretes through carbonation of iron dust. For example, in some embodiments, iron can react with aqueous CO₂ under controlled conditions to form complex iron carbonates which have binding capabilities. Further, some embodiments can include additives comprising silica and alumina. In some embodiments, silica and/or alumina additives can facilitate iron dissolution, which in some embodiments can provide beneficial rheological characteristics and properties. In some embodiments, the binder system can rely on the effects of corrosion of iron particles to form a binding matrix. In this instance, binder formation can result in the consumption and trapping of CO₂ from an industrial operation and subsequent carbonate formation by conversion of at least a portion of the iron particles. Further, the binder formation can provide a means to reduce the overall ordinary Portland cement production (which is itself a significant emitter of CO₂) through the use of carbonated metallic iron powder as the binder material for concrete. As used herein, the term metallic iron powder can include powders or particulate compositions comprising iron powder, steel powder, mixtures of iron and steel powder, fine particulates containing 10% or more reduced or metallic iron, or mixtures thereof.

In some embodiments, dissolution agents (such as organic acids) can be added to enhance the corrosion rate of iron. Further, in some embodiments, the rheological behavior (flowability and castability) and early strength development can be improved using one or more additives. For example, additives common to Portland cement concretes such as class F fly ash, powdered limestone, and metakaolin can be used as minor ingredients along with metallic iron powder to form pastes with adequate binding capabilities. In some embodiments, fly ash can be added as a source of silica to potentially facilitate iron silicate complexation. Further, in some embodiments, limestone powder can be added to provide additional nucleation sites. Some embodiments include one or more “powdered” clays having a layered structure which retains water and which can be used to improve the rheological properties. For example, in some embodiments, a clay source such as kaolinite and/or metakaolin can be added to provide cohesiveness as the iron-based mixtures are prepared.

Some embodiments provide compositions comprising fly ash, limestone, and a clay source such as metakaolin and/or kaolinite in various proportions. In some embodiments, the proportions of iron powder and other additives (including for example organic acids as dissolution agents) can influence the curing regime (based at least in part on the exposure of the mixture to CO₂ and/or air). In some embodiments, the iron powder comprises about 88% iron and about 10% oxygen, along with trace quantities of copper, manganese, and calcium. In some embodiments, a binder composition can include class F fly ash. In some further embodiments, the composition can comprise metakaolin conforming to ASTM C 618.

In further embodiments, the binder composition can comprise limestone powder. In some embodiments, the limestone powder can comprise a median particle size of about 0.7 μm conforming to ASTM C 568. In some embodiments, limestone can be added with a particle size that can range from a median size of about 0.7 μm to about 20 μm. In some embodiments, the fineness determines its nucleation ability.

Some embodiments of the invention include compositions comprising metallic iron powder with median particle size of about 19 μm. In some embodiments, metallic iron powder sizes can range from about 5 μm to about 50 μm. Further, in some embodiments, the selection of size ranges can facilitate reactivity. In some embodiments, the iron powder can be obtained from a shot-blasting facility. In some embodiments, the iron powder can be derived from waste steel dust (such as so-called “bag house dust” from a shot blasting operation). In some embodiments, the waste dust comprises fine residue from blasting structural steel components such as I-beams with steel shot (round) or grit (angular). In this example, the shot and grit break down during numerous cycles of being blasted against steel targets. Other sources of the iron or steel powder can be from brake drum turnings, mill scale (if containing >10% metallic iron), machine shop shavings, finely chopped sheet steel and other waste ferrous scrap, and other sources of fine particulates containing particles of <50 um in size and containing about 10% or more of metallic iron. In some further embodiments, synthesized pure metallic iron powder can be used such as electrolytic iron powder and hydrogen-reduced iron powder.

In some embodiments of the invention, the curing of the binder composition can be integrated into a conventional furnace process to take advantage of the use of CO₂ emitted from the convention process, and from the potential to recycle energy, reduce waste, and potentially lower costs by recycling gases from binder reaction and curing processes described above. For example, in some embodiments, CO₂ from a conventional process can be used to provide a source of reactant in equation (1) or (3) described earlier. Further, in some embodiments of the invention, H₂ emitted from the reactions (1) or (3) can be used within at least one reaction and/or process of the convention process.

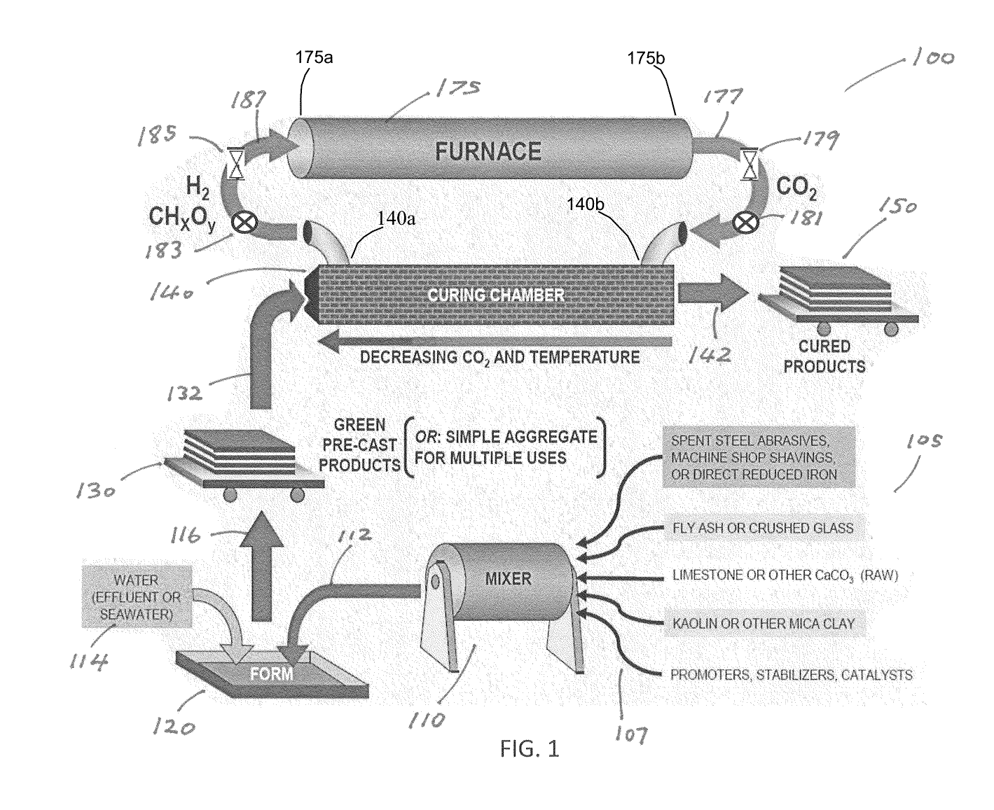

FIG. 1 illustrates a schematic of a method of synthesis and processing of binder compositions using a recycled reaction products integrated within a source of CO₂ (such as a conventional furnace process) in accordance with some embodiments of the invention. In some embodiments of the invention, binder components 105 can be prepared and fed using a delivery process 107 into a mixing process 110. In some embodiments, the binder components 105 can be mixed using the mixing process 110 to produce any of the binder mixtures described herein. The mixing process can comprise any conventional mixing process including ball-milling, low-shear mixing, high-shear mixing, rotary-blade mixing, acoustic mixing, extrusion mixing, shaker-mixing, or any other conventional binder mixing process. In some embodiments, binder components 105 can be mixed until a binder mixture is produced that is generally homogenous. The mixing time can be dependent on the mixer and the binder components 105 may be mixed for longer or shorter periods based on the composition and the mixer type.

In some embodiments, a mixture 112 can be transferred to a form or mold 120. In some embodiments, water and/or seawater 114 can be added and an uncured aggregate can be formed into a form or mold 120. In some embodiments, uncured forms 130 can be transferred (transfer process 116) from the form or mold 120 and assembled and/or prepared for transfer 132 to a curing chamber 140.

In some embodiments of the invention, the curing chamber 140 can be fluidly coupled to a CO₂ source (such as a conventional reactor or furnace 175). For example, in some embodiments, at or adjacent to or proximate to a first end 140a of the curing chamber 140, a fluid coupling 187 can be coupled at one end and coupled to a first end 175a of the conventional furnace 175. Further, for example, in some embodiments, at or adjacent to or proximate to a second end 140b of the curing chamber 140, a fluid coupling 177 can be coupled at one end and coupled to a second end 175b of the conventional furnace 175. In some other embodiments, the CO₂ source can comprise other sources of CO₂ including, but not limited to, an existing industrial process comprising the CO₂ source such as a furnace of the existing industrial process, a furnace, a boiler, a reactor or process vessel, a power station or generator, an oil or gas well or field, a natural or synthetic CO₂ aquifer, a CO₂ sequestration apparatus, and/or the atmosphere or environment.

In some embodiments, the fluid couplings 177, 187 can include at least one meter for metering a fluid flow and/or at least one valve for altering or adjusting a fluid flow. For example, in some embodiments, the fluid coupling 177 can comprise a fluid valve 181. In some further embodiments, the fluid coupling 187 can comprise a fluid valve 183. In some further embodiments, the fluid coupling 187 can comprise a fluid meter 185. In some other embodiments, the fluid coupling 177 can comprise a fluid meter 179.

In some embodiments of the invention, the fluid valve 181 can at least partially restrict or stop fluid flow in the fluid coupling 177 between the conventional furnace 175 and the curing chamber 140. In some further embodiments of the invention, the fluid valve 183 can at least partially restrict or stop fluid flow in the fluid coupling 187 between the conventional furnace 175 and the curing chamber 140.

In some embodiments of the invention, the fluid meter 179 can measure or monitor a fluid flow in the fluid coupling 177 between the conventional furnace 175 and the curing chamber 140. In some further embodiments of the invention, the fluid meter 185 can measure or monitor fluid flow in the fluid coupling 187 between the conventional furnace 175 and the curing chamber 140.

In some embodiments of the invention, with uncured forms 130 entering and/or moving, and/or stationary within the curing chamber, fluids including H₂ and/or CHₓO_{y} (where x can be between zero and four, and y can be between zero and two) can pass from the curing chamber 140 through the fluid coupling 187 into the conventional reactor or furnace 175. Further, in some embodiments, CO₂ producing within the conventional reactor or furnace 175 can flow from the conventional reactor or furnace 175 to the curing chamber 140. In some embodiments, the flow of CO₂ can be measured or monitored with the fluid meter 179. In some further embodiments, the flow of CO₂ from the conventional reactor or furnace 175 to the curing chamber 140 can be modified or halted using the fluid valve 181.

In some embodiments, the flow of fluids from the curing chamber 140 to the conventional reactor or furnace 175 including H₂ and/or CHₓO_{y} can be measured or monitored with the fluid meter 185. In some further embodiments, the flow of fluids including H₂ and/or CHₓO_{y} from the curing chamber 140 to the conventional reactor or furnace 175 can be modified or halted using the fluid valve 183.

In some embodiments of the invention, the flow of fluids including H₂ and/or CHₓO_{y} from the curing chamber 140 to the conventional reactor or furnace 175 is based at least in part on a cure reaction (e.g., from a reaction shown in equation 1) of the uncured products 130 during conversion to a cured product 150 that can exit the curing chamber 140 through a process 142. Further, in some embodiments of the invention, at least a portion of the curing and conversion of the uncured products 130 to cured product 150 can be dependent at least in part on CO₂ delivered from one or more reactions or processes of the conventional reactor or furnace 175.

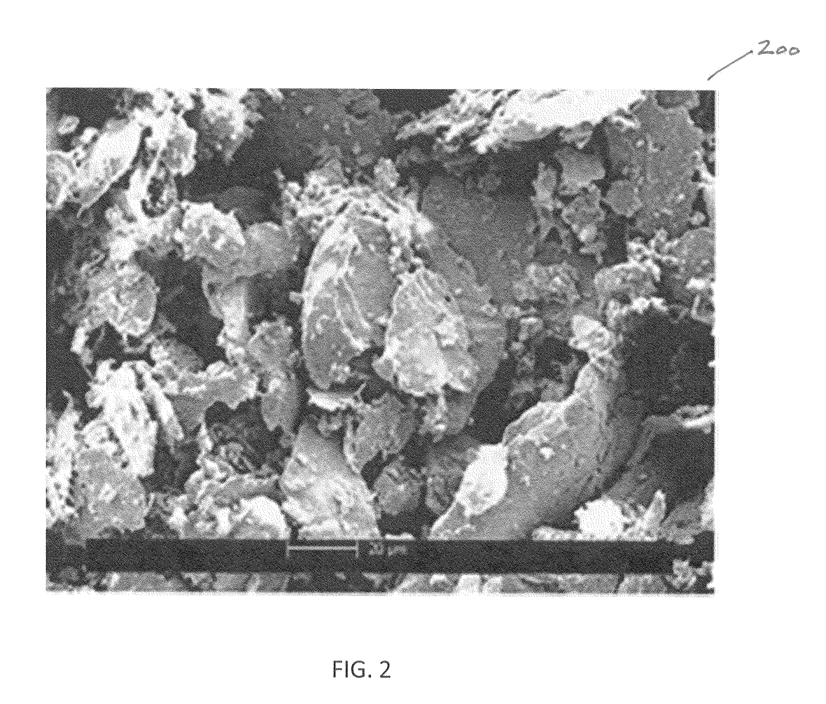

FIG. 2 provides an illustrative view of a scanning electron micrograph 200 of iron particles (where the scale bar corresponds to 20 μm) according to one embodiment of the invention. As shown, the iron powder can include elongated and plate-like particles. In some embodiments, the elongated and plate-like particles can influence the rheological properties of the mixture. Further, in some embodiments, the larger surface area-to-volume ratio of this shape as compared to spherical shaped particles can improve reactivity of the iron powder. In some embodiments, fly ash can be used to provide a silica source for the reactions (and to potentially facility iron silicate complexation). In some embodiments, added limestone powder can provide nucleation sites for one or more cure reactions within the binder composition. In some embodiments, added water can be reduced in chemical reactions within any of the disclosed binder compositions (however it does not form part of the binder). In some embodiments, to minimize water demand, while maintaining binder consistency and cohesiveness, added metakaolin can be added to the binder composition. In some further embodiments, an organic reducing agent/chelating agent of metal cations can be included in the binder composition.

In some embodiments, various iron-based binder compositions were prepared and compared with commercially available type I/II ordinary Portland cement (hereinafter “OPC”). For example, in some embodiments, OPC conforming to ASTM C 150 was used to prepare conventional cement pastes, and the compressive strengths of the iron-based binder compositions were compared with those of the traditional OPC-based systems. In some embodiments, OPC was also partially replaced by class F fly ash and blast furnace slag up to about 40% and about 50% respectively by mass for comparison purposes. Fly ash generally contains about 60% by mass of SiO₂, whereas the siliceous content of metakaolin is about 50%. In some embodiments, the limestone powder used comprises a nominally pure calcium carbonate (about 97% by mass).

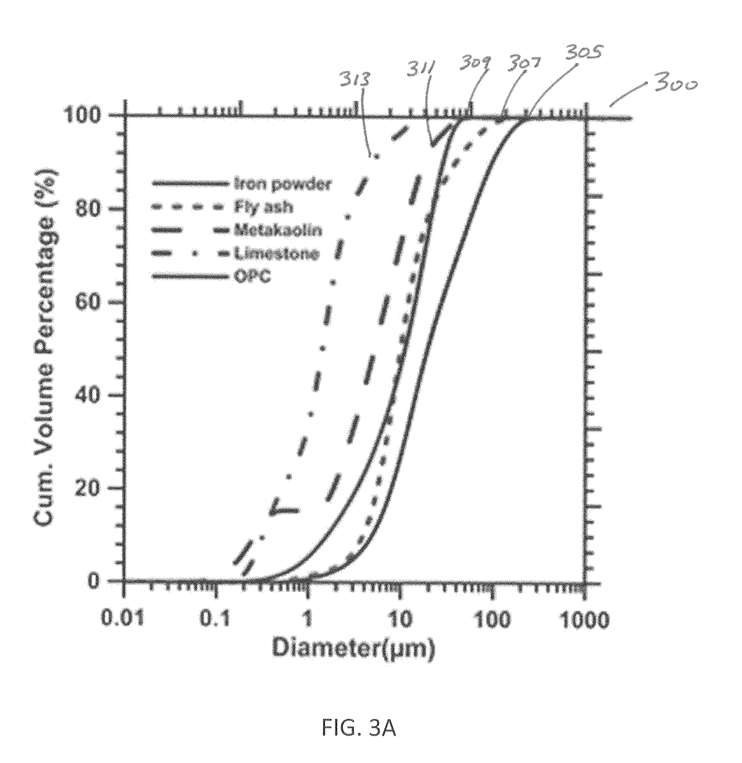

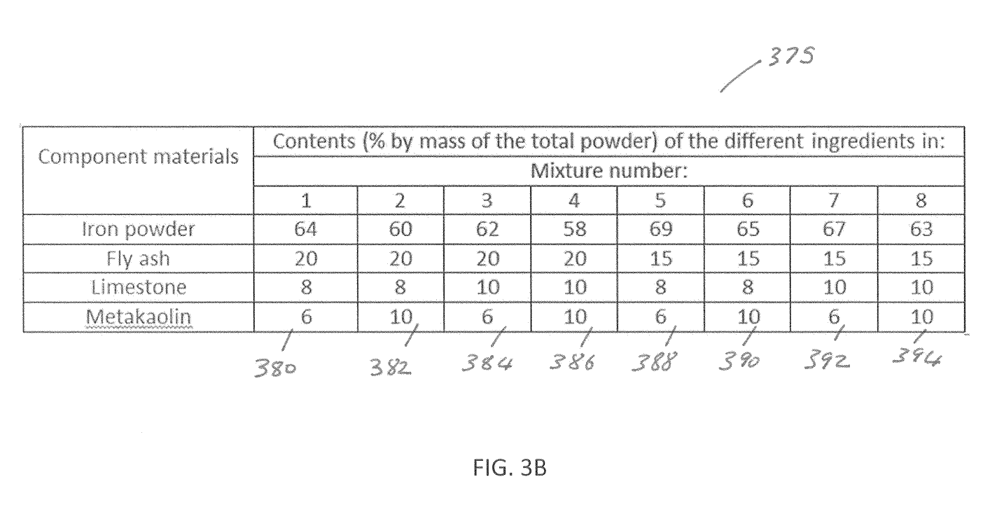

FIG. 3A shows a plot 300 of particle size distribution (obtained from a laser diffraction-based particle size analyzer) of metallic iron powder (data plot 305), OPC (data plot 309), fly ash (data plot 307), metakaolin (data plot 311) and limestone powder (data plot 313) in accordance with at least one embodiment of the invention. In some embodiments, binder composition preparation methods can include dry mixing of all materials (iron powder, fly ash, limestone powder, a clay source such as metakaolin and/or kaolinite, and an organic reducing agent). In some embodiments, water can be added to some of the dry ingredients and the other ingredients can then mixed in order to obtain a uniform cohesive mixture. In some embodiments, the mass-based water-to-solids ratio (hereinafter “w/s”) was varied between about 0.22 and about 0.25 depending upon the proportions of the constituents in the mixtures to attain a cohesive mix. As described earlier, since the carbonation process of iron does not incorporate water in the reaction product, the w/s used can be primarily based on the criteria of obtaining desired workability, casting behavior, and ability to strip the cured composition from molds without specimen breakage.

In some embodiments of the method, the mixture was transferred to cylindrical molds (about 32.5 mm diameter and about 65 mm long) in a Harvard miniature compaction apparatus (ASTM D 4609—Annex A1) in five layers to fill the mold completely. In some embodiments, the specimens were de-molded immediately using a specimen ejector for the compaction apparatus, and placed inside clear plastic bags filled with 100% CO₂ at room temperature (between about 18° C. and about 22° C.) inside a fume hood for 1 to 4 days. In some embodiments, the bags were refilled with CO₂ every 12 hours so as to maintain saturation inside the chamber. In some embodiments, after the respective durations of CO₂ exposure, the samples were placed in air at room temperature (between about 18° C. and about 22° C.) to allow the moisture to evaporate for 1 to 30 days. In some embodiments, the OPC-based samples were cast in 50 mm cube molds and moist-cured (>98% RH and 23±2° C.) for 7 days before compressive strength testing. In some embodiments, the water-to-cementitious materials ratio (hereinafter “w/cm”) adopted for the OPC-based mixtures was about 0.40, which is the most common w/cm used for moderate strength (20-35 MPa) concretes.

As described earlier, some embodiments comprise binder compositions including various mixture proportions of iron powder, and at least one of fly ash, limestone powder, a clay source such as kaolinite and/or metakaolin, and one or more organic reducing agents. Further, in some embodiments, binder compositions can be cured using various curing procedures. For example, different mixtures with varying iron powder, fly ash, limestone, and a clay source such as metakaolin and/or kaolinite contents can be proportioned to select one or more compositions based on compressive strength of the cured binder composition. For example, some binder compositions include an iron powder content that ranged from about 58 to about 69% by mass. In some embodiments, the fly ash content was maintained at about 15% or about 20%. Further, in some embodiments, a limestone content of about 8% to about 10% was used. Further, some embodiments included a metakaolin content of about 6% to about 10%. In some embodiments, the w/s ratios varied between about 0.22 and about 0.25. These preliminary proportions were arrived at based on several trial proportions that used iron powder from about 50 to about 100% of the total binder content. Moreover, the binder composition included other ingredients at multiple levels beyond the ranges described above, and several w/s ratios in the range of about 0.15 to about 0.30.

FIG. 3B illustrates a table (375) of compositions comprising mixtures of iron powder, fly ash, limestone and metakaolin in accordance with at least one embodiment of the invention. The proportions of the eight short-listed mixtures are shown, and were chosen based on the homogeneous nature of the mixture, their ability to be compacted into molds, and their ability to be demolded without breakage. As shown, in some embodiments, the binder composition can comprise about 64% iron powder, about 20% fly ash, about 8% limestone, and about 6% metakaolin (“mixture 1” marked as 380). In some further embodiments, the binder composition can comprise about 60% iron powder, about 20% fly ash, about 8% limestone, and about 10% metakaolin (“mixture 2” marked as 382). In some other embodiments, the binder composition can comprise about 62% iron powder, about 20% fly ash, about 10% limestone, and about 6% metakaolin (“mixture 3” marked as 384). Some embodiments include a binder composition that comprises about 58% iron powder, about 20% fly ash, about 10% limestone, and about 10% metakaolin (“mixture 4” marked as 386). In some embodiments, the binder composition can comprise about 69% iron powder, about 15% fly ash, about 8% limestone, and about 6% metakaolin (“mixture 5” marked as 388). In some other embodiments, the binder composition can comprise about 65% iron powder, about 15% fly ash, about 8% limestone, and about 10% metakaolin (“mixture 6” marked as 390). In some further embodiments, the binder composition can comprise about 67% iron powder, about 15% fly ash, about 10% limestone, and about 6% metakaolin (“mixture 7” marked as 392). Some further embodiments of the invention include a binder composition comprising about 63% iron powder, about 15% fly ash, about 10% limestone, and about 10% metakaolin (“mixture 8” marked as 394). In some embodiments of the invention, the binder components 105 can comprise any of the mixtures 380, 382, 384, 386, 388, 390, 392.

In some embodiments, the organic reducing agent comprises an acid. In some embodiments, the organic reducing agent comprises oxalic acid. In some embodiments, the acid can comprise at least one carboxylic acid group. In some embodiments, an organic reducing agent can be added in a powder form to about 2% of total mass of the constituents. In some other embodiments, the organic reducing agent can be added based on the solubility of the organic acid in water, and the compressive strength as compared to mixtures without dissociating agent. In some embodiments of the invention, the binder components 105 can comprise any of the mixtures 380, 382, 384, 386, 388, 390, 392 that also comprise 2 wt % of an organic acid including, but not limited to oxalic acid or any organic carboxylic acid.

In some embodiments, binder composition samples were kept in a 100% CO₂ atmosphere for 3 days immediately after casting and de-molding, and cured in air for 2 days before they were tested in uniaxial compression. In some embodiments, in order to determine the optimal combination of CO₂ and air-curing durations, the CO₂ curing exposure duration was varied from 1 to 4 days, and the air curing duration varied from 1 to 3 days. In some embodiments, the upper limit of the carbonation duration was chosen based on the thermo-gravimetric analysis which showed similar degrees of carbonation in the core and surface of the cylindrical samples after 4 days of carbonation. In some embodiments, air-curing was extended to 30 days, but no appreciable changes in compressive strengths were found after 3 days.

Physical characterization was performed on one or more of the cured binder compositions described above. For example, flexural strength tests were carried out on mixtures under compression. Paste beams, 250 mm×25 mm×25 mm in size were prepared and cured in a 100% CO₂ environment for 2-6 days. The air exposure time was maintained constant at 3 days. Three-point bending tests were conducted at a displacement rate of 0.375 mm/min until the samples failed. Thermo-gravimetric analysis was performed using a Perkin Elmer STA 6000 simultaneous thermal analyzer. The analyzer was programmed to increase the temperature from 30° C. to 995° C. at a rate of 15° C./minute in a N₂ environment. The samples were obtained from cylindrical samples that were cured for the compressive strength tests. Samples from both surface as well as core of the cylindrical specimens were analyzed in order to assess the influence of CO₂ penetration on the degree of reaction. Mercury intrusion porosimetry was adopted to study the pore structure. The samples for MIP tests were taken from the core of the cylindrical sample. The MIP test was done in two steps: (i) evacuation of gases, filling the sample holder with mercury, and increasing the pressure up to 345 kPa, and (ii) intrusion of the mercury into the sample at high pressures (up to 414 MPa). The contact angle and surface tension of Hg used for the analysis was 0.485 N/m. In the absence of a better understanding of the contact angle between Hg and the iron carbonate binder, the common value used for OPC-based pastes (130°) was used here. The pore diameters were evaluated using the Washburn equation based on the assumption that the pores are of cylindrical shape. A minimum pore diameter of 0.003 μm can be evaluated using MIP. The average pore diameter (dₐ) can be estimated for varying carbonation durations using the total volume of mercury intruded (V, cm³/g) and the pore surface area (A, cm²/g) obtained from MIP as shown below:

dₐ=(4V/A)

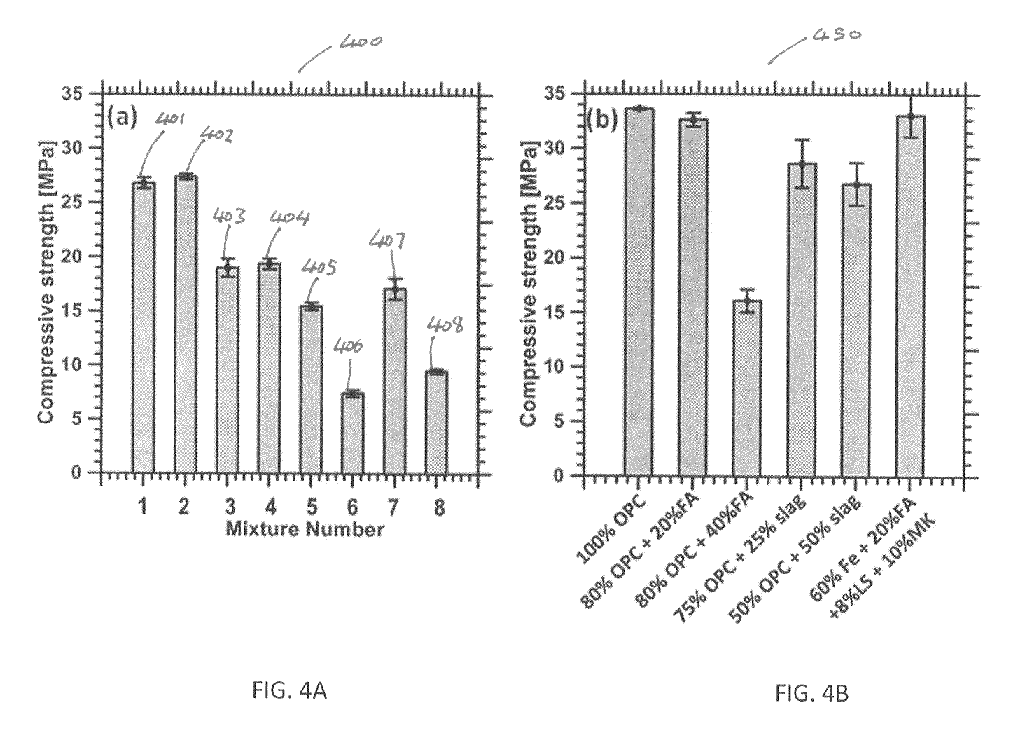

In some embodiments, the compressive strength of one or more of the binder compositions measured to determine the behavior of compressive strength for a specific curing duration and procedure. In some embodiments, binder composition samples were kept in a CO₂ environment for 3 days and then cured in air for 2 days at 23±2° C. to get a comparative measure of the compressive strengths of one or more compositions. For example, FIG. 4A illustrates a plot of compressive strength values of mixtures after 3 days in CO₂ and 2 days in air in accordance with various embodiments of the invention. The results show compressive strength bars 401, 402, 403, 404, 405, 406, 407, 408 corresponding to the mixtures shown in table 375, including 380, 382, 384, 386, 388, 390, 392, and 394 respectively. Further, FIG. 4B illustrates a plot of compressive strength values of mixtures showing 7-day compressive strengths of plain and modified OPC mixtures for comparison with 4-day carbonated iron-carbonate (mixture 2: 60% iron powder, 20% fly ash, 8% limestone, 10% metakaolin) in accordance with various embodiments of the invention.

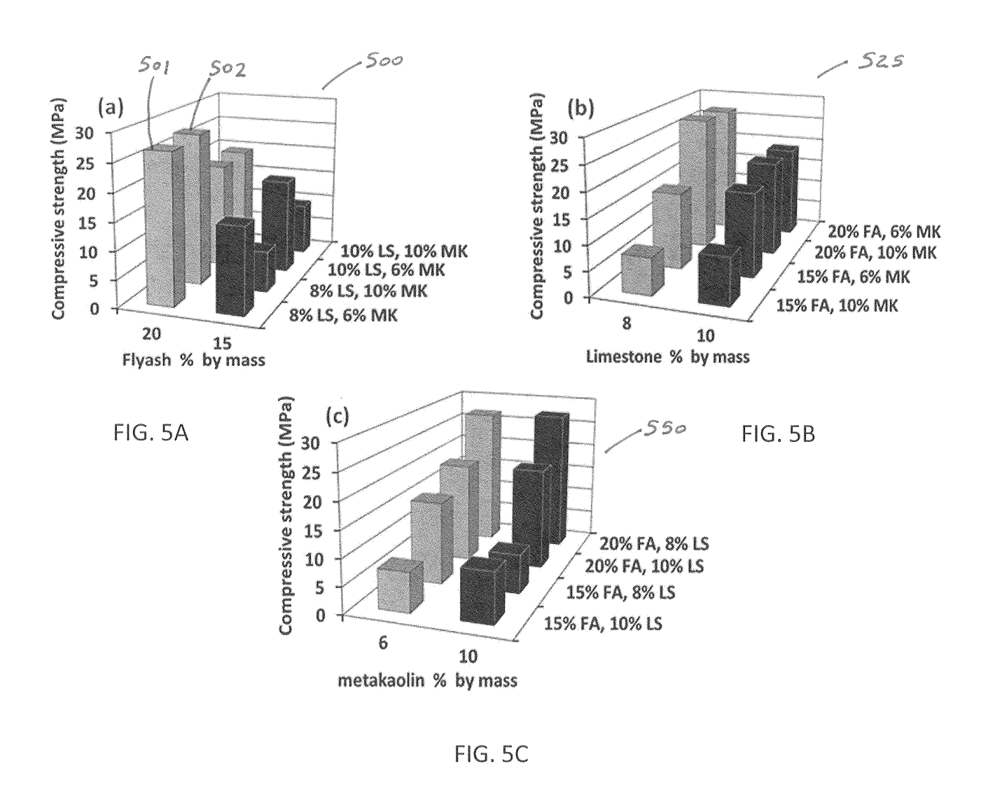

The influence of various constituents on compressive strength is illustrated in FIGS. 5A-5C. For example, FIG. 5A illustrates a plot 500 of the effect of fly ash content on the compressive strength of iron carbonate binders in accordance with some embodiments of the invention. FIG. 5B illustrates a plot 525 of the effect of limestone content on the compressive strength of iron carbonate binders, and FIG. 5C illustrates a plot 550 of the effect of metakaolin content on the compressive strength of iron carbonate binders in accordance with some embodiments of the invention. The results illustrated in FIG. 5A implies that the samples with 20% fly ash (shown as 501, 502) were significantly stronger than the samples with 15% fly ash, irrespective of the contents of limestone and metakaolin. In this instance, the best performing mixtures (mixture 1 shown as 501, and mixture 2 shown as 502) contained 20% fly ash by mass. These mixtures also demonstrated the lowest porosity (determined from mercury intrusion porosimetry), possibly due to the combined effect of particle packing and increased reaction product formation. From FIG. 5B, it can be seen that in some embodiments, the limestone content exerts negligible influence on compressive strength at lower fly ash contents, but at higher fly ash contents, a lower amount of limestone powder is preferable. Further, in some embodiments, the compressive strength is relatively insensitive to variations in metakaolin content for the samples containing 20% fly ash. Thus, in some embodiments, the synergistic effect of silicates and cohesive nature of metakaolin can ensure a denser matrix. In some embodiments of the invention, with a binder comprising a lower fly ash content, an increase in the metakaolin content is associated with significant decrease in the compressive strength values. In some embodiments, this can be attributed to the increased water retention by metakaolin, and the lack of quantity of fly ash to enhance the workability and produce a consistent and defect-free mixture.

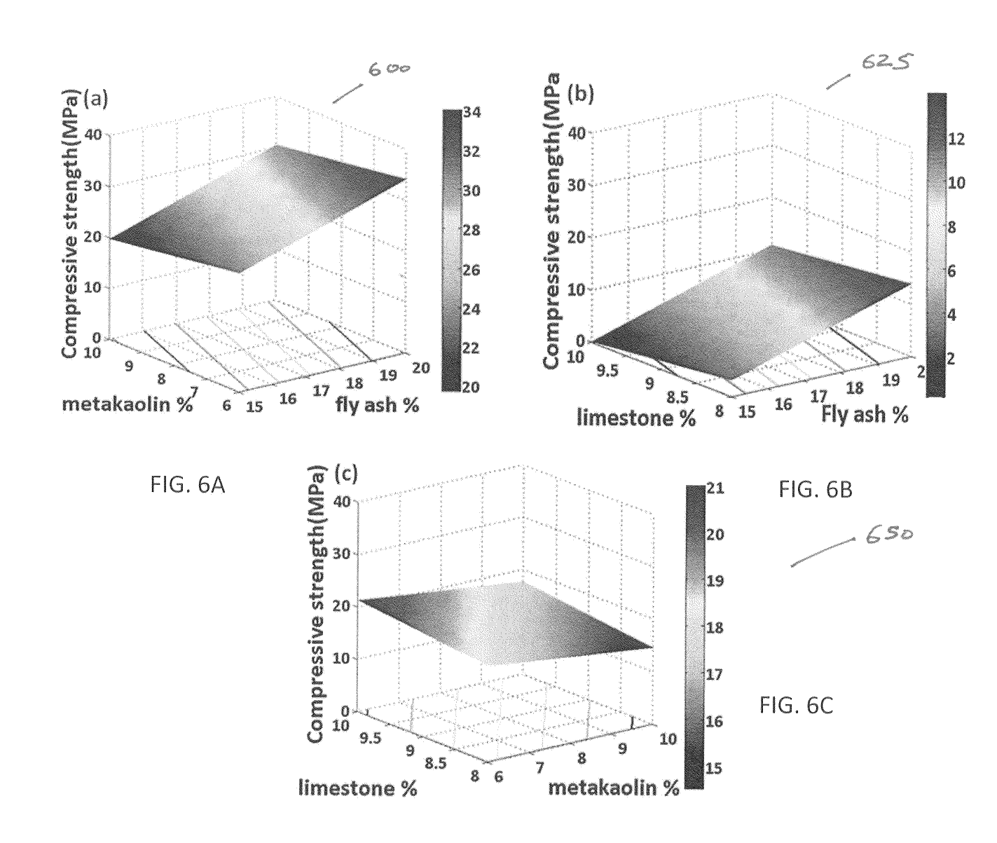

In some embodiments, the statistical influence of the amounts of fly ash, metakaolin and limestone on the compressive strength and the relative sensitivity of strength to these factors can be determined using a 2³ factorial analysis. For example, FIG. 6A illustrates a response surface plot 600 showing the statistical influence of amounts of fly ash and metakaolin in accordance with some embodiments of the invention. Further, FIG. 6B illustrates a response surface plot 625 showing the statistical influence of amounts of fly ash and limestone in accordance with some embodiments of the invention, and FIG. 6C illustrates a response surface plot 650 showing the statistical influence of amounts of limestone and metakaolin in accordance with some embodiments of the invention. It is confirmed that fly ash is the dominant factor influencing the compression strength. The sensitivity of compressive strength to variations in the amount of limestone and metakaolin is relatively low. As described earlier, metakaolin is used as a rheology modifier (modifying the overall cohesiveness of the binder mixture), and the limestone can function as a nucleation site for the reaction products.

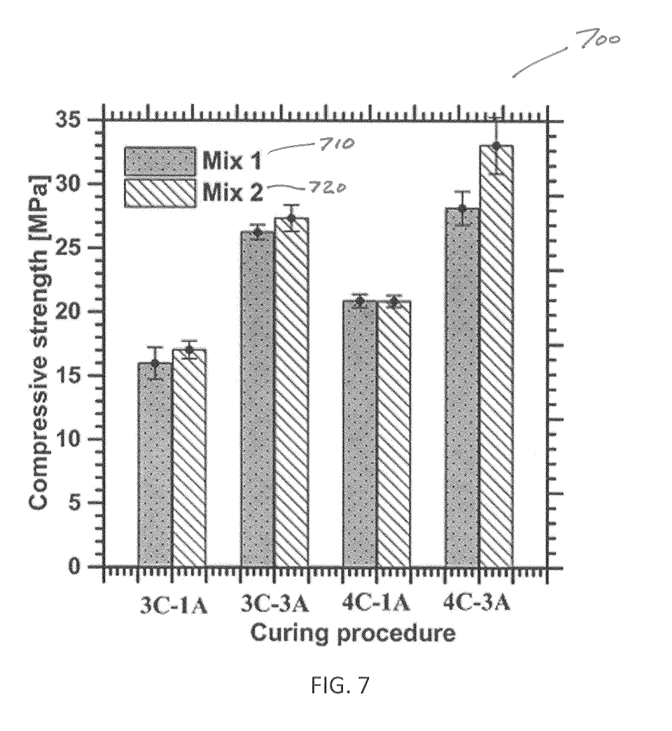

The range of amount of limestone used in the compositions described herein (about 8-10%) does not significantly impact the strength, however thermogravimetric analysis indicates some consumption of limestone in the reaction to form a carbonate-containing complex reaction product. As discussed earlier, the data illustrated in FIG. 2A does not indicate significant differences in compressive strengths between mixtures 1 and 2 under the chosen curing condition (in a CO₂ environment for 3 days and air-cured for 2 days). To observe whether changes in curing conditions would elicit varied response from these mixes, the cylindrical specimens were carbonated for 3 or 4 days and air-cured for 1 or 3 days. FIG. 7 shows a bar graph 700 of the comparison of compressive strength of mixture 1 (comprising 64% iron powder, 20% fly ash, 8% limestone, 6% metakaolin) and shown as 710, and mixture 2 (comprising 60% iron powder, 20% fly ash, 8% limestone, 10% metakaolin) shown as 720, under different curing conditions in accordance with some embodiments of the invention. Here the number before ‘C’ represents the days of carbonation whereas the number before ‘A’ represents the air exposure time in days. Therefore, as an example, “3C-1A” represents three days of carbonation and one day of air exposure time.

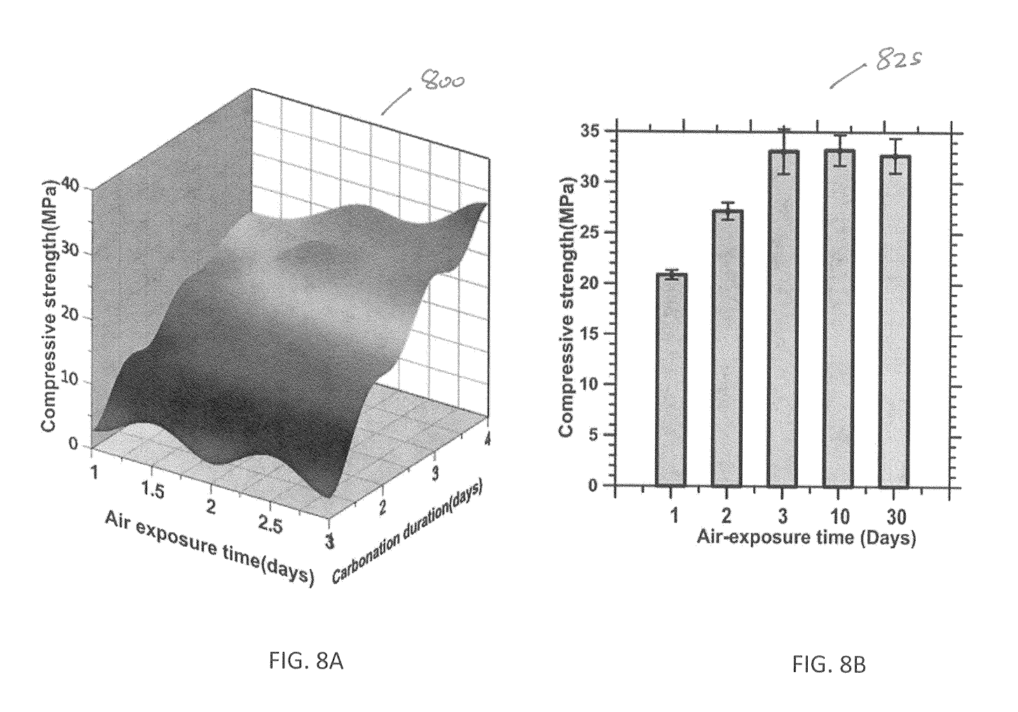

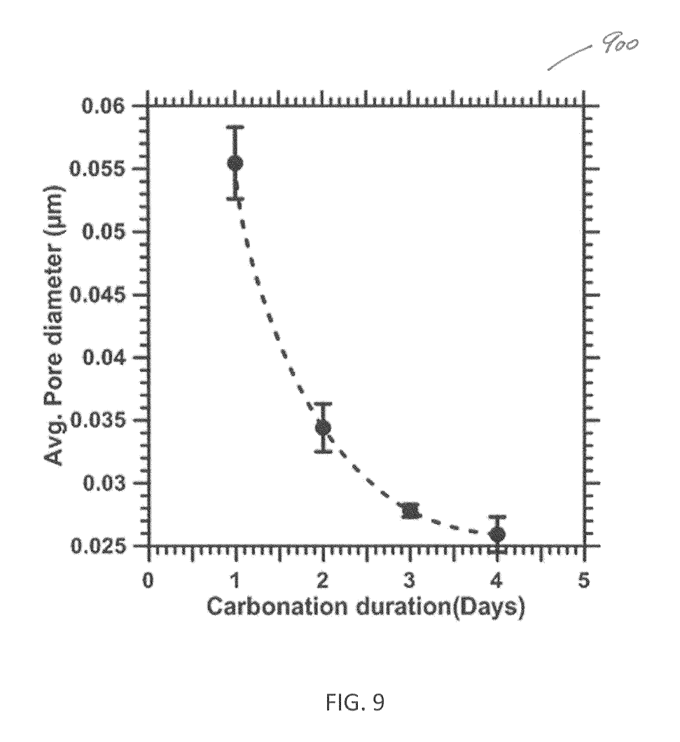

The effects of curing procedure and duration on compressive strengths of the iron carbonate binders are shown in FIGS. 8A and 8B. For example, FIG. 8A illustrates a surface plot 800 of the effect of curing procedure and curing duration in accordance with some embodiments of the invention. Further, FIG. 8B shows a bar graph 825 of the effect of air-curing duration on compressive strength of mixture 2 (comprising 60% iron powder, 20% fly ash, 8% limestone, 10% metakaolin), and carbonated for 4 days in accordance with some embodiments of the invention. In some embodiments, the samples were cured in CO₂ for 1 to 4 days and in air for 1 to 3 days thereafter. Referring to FIG. 8A, the strength values are shown in a response surface plot as function of CO₂ and air-curing durations. As illustrated, in some embodiments, the influence of CO₂ curing duration shows low compressive strength values for the samples cured in CO₂ for 1 day only (due to the very low degree of carbonation). In some embodiments, the carbonation provides mechanical strength in the binder compositions. Moreover, in some embodiments, there is no discernible strength increase when the moisture leaves the system through air exposure. This can be seen where for 1 day of carbonation, increasing the air exposure duration from 1 to 3 days does not impact the compressive strength positively. However, the effect of air-curing is evident when the carbonation duration is increased. In some embodiments, a significant increase in strength is observed for specimens carbonated for a longer duration when the air curing time was increased. This can be attributed to the fact that the average pore sizes decrease with increased carbonation duration as shown in FIG. 9, which illustrates plot 900 showing variations in average pore diameter with varying carbonation durations for mixture 2 (60% iron powder, 20% fly ash, 8% limestone, 10% metakaolin).

In some embodiments, the average pore size of the 1-day carbonated samples is larger, which in some embodiments can consequently exert less internal moisture pressure under a compression test (pressure is inversely proportional to the pore size). Therefore, in some embodiments, the loss of moisture through air exposure does not have a larger effect on internal pressure (and thus the compressive strength). Further, in some embodiments, the pore sizes of samples carbonated for a longer duration are lower due to increased reaction product formation, which in some embodiments, results in an increased sensitivity of compressive strength to the loss of moisture.

In order to further illustrate the effect of air exposure, FIG. 8B plots the compressive strengths as a function of air exposure duration after the samples were carbonated for 4 days. As illustrated, in some embodiments, the first three days of exposure to air results in an enhancement in the compressive strength. Further, as the moisture dries out completely, there is no significant change in compressive strength which signifies that the reaction product is passive and stable in air, and does not cause deterioration when exposed to air for longer time periods. Thus, in some embodiments, the air exposure duration (which is dependent on the pore structure that can allow moisture to escape from the bulk of the material) can influence the compressive strength at longer carbonation durations.

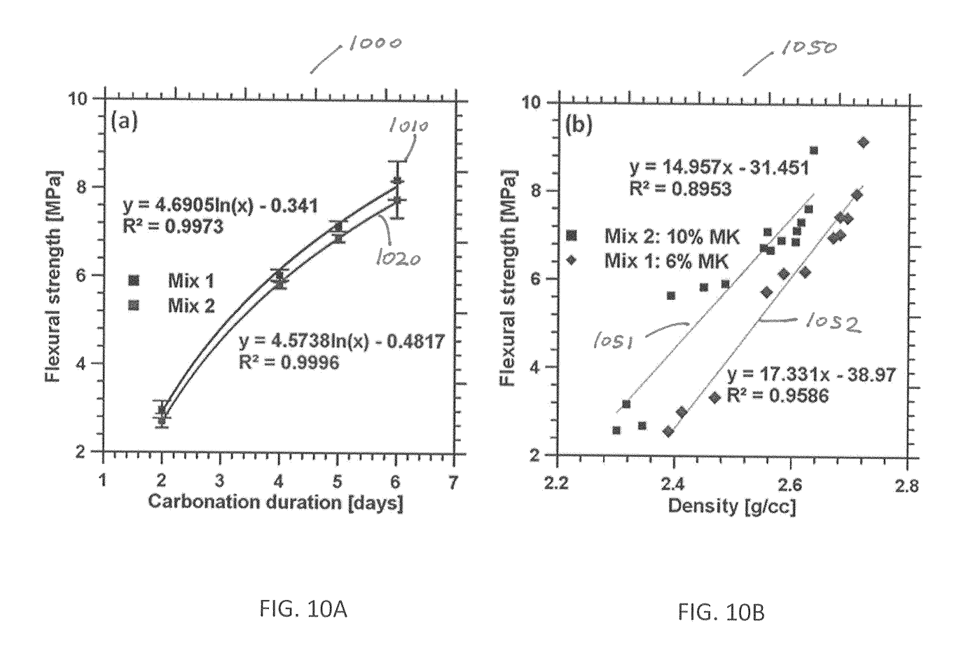

FIG. 10A shows graph 1000 showing the variation in flexural strength of iron carbonate binders (for mixtures 1, shown as plot 1010 and mixture 2, shown as plot 1020) with an increase in carbonation duration. As shown, in some embodiments, the flexural strengths are very similar for both the mixtures, which is consistent with the trends for compressive strength. Further, a carbonation duration of six days can result in a relatively high flexural strength of about 8 MPa. In comparison, typical OPC-based systems demonstrate a flexural strength of 3-4 MPa. Therefore, in some embodiments of the invention, the increased flexural strength of the binder compositions provides options for several applications that require improved flexural properties (such as beams, pavement slabs, and the like). FIG. 10B shows a graph 1050 with the relationship between flexural strength and density for mixture 1 (shown as plot 1052) and mixture 2 (shown as 1051). In some embodiments, higher carbonation durations results in more reaction product formation and increased density as the reaction product fills the pores more efficiently. Further, in some embodiments, the iron-based binder paste is only about 20-25% denser that common Portland cement-based pastes. In some embodiments, concretes that contain about 70% aggregates by volume, the density differences drops down to about 10%.

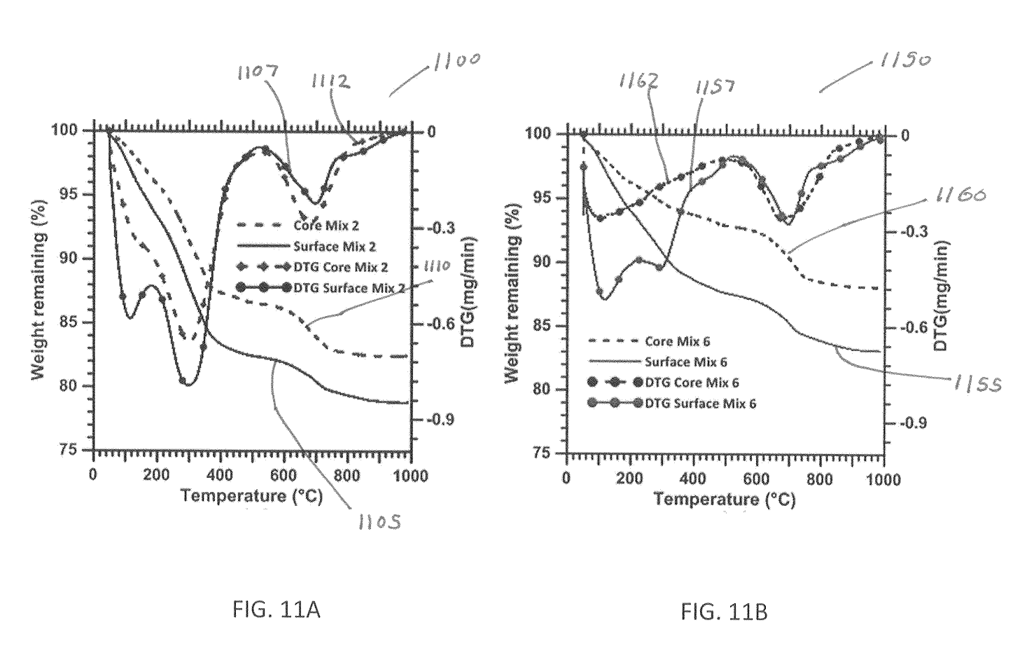

In some embodiments, thermo-gravimetric analysis was performed on powdered samples extracted from the surface and core of cylindrical specimens prepared from various binder compositions disclosed herein to investigate the degree of reaction responsible for differences in mechanical properties. The thermal analysis results of mixtures 2 and 6 were compared in order to understand the differences in product constitution between samples with the best and worst compressive strength. FIG. 11A shows a plot 1100 including thermogravimetric and differential thermogravimetric (DTG) curves corresponding to the core and surface of mixture 2 (comprising 60% iron powder, 20% fly ash, 8% limestone, 10% metakaolin), carbonated for 3 days. For example, plot 1105 shows data for the surface of mixture 2, and plot 1110 shows the data for the core of mixture 2. The corresponding DTG curves are shown as plots 1107, 1112. Further, FIG. 11B shows a plot 1150 including thermogravimetric and differential thermogravimetric curves corresponding to the core and surface of mixture 6 (comprising 65% iron powder, 15% fly ash, 8% limestone, 10% metakaolin), carbonated for 3 days in accordance with some embodiments of the invention. For example, plot 1155 shows data for the surface of mixture 2, and plot 1160 shows the data for the core of mixture 2. The corresponding DTG curves are shown as plots 1157, 1162.

A comparison of FIGS. 11A and 11B suggests that the total weight loss for mixture 2 is significantly higher than that for mixture 6, indicating that in some embodiments, the overall degree of reaction and product formation is lower under the chosen carbonating conditions for the starting material combination of mixture 6. Further, in some embodiments, the total weight loss of the sample from the surface of mixture 6 cylinder is slightly lower than the weight loss from the core sample of mixture 2. This shows that the constitution of mixture 6 is not reactively sensitive to desirable levels of carbonation and product formation, which reflects in the compressive strength of the binder. This observation also indicates that in some embodiments, the carbonation efficiency and mechanical properties of iron carbonate binders are very sensitive to the overall starting material composition. From a compositional viewpoint, the differences between mixtures 2 and 6 are not very large (the range of iron powder contents that provided reasonable strengths were between about 60% and about 69%). In some embodiments, the DTG curves include three distinct peaks for the binder samples. In some embodiments, the peak at around 110° C. can be attributed to evaporable water, and the peak at around 300° C. can be attributed to products belonging to the carbonate-oxalate-cancrinite group. In some embodiments, and the peak at around 740° C. can be attributed to calcium carbonate. The DTG curve for mixture 2 shows a strong, distinct peak at about 300° C. (for samples from both the core and the surface) whereas the intensity of the peak reduces for samples from mixture 6. The peak is almost non-existent for the sample from the core of mixture 6, indicating that in some embodiments, the carbonation efficiency for that mixture constitution is low.

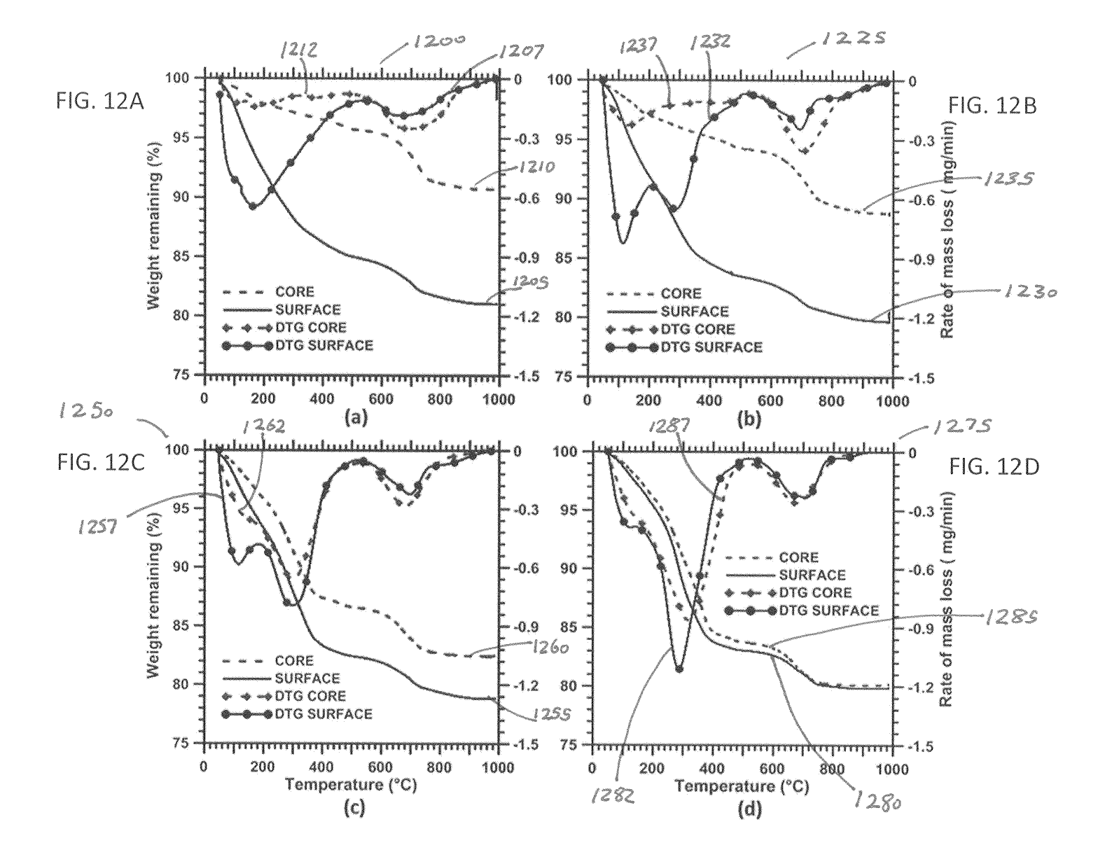

Further, in some embodiments, the effect of carbonation duration on reaction product formation can be evaluated for one or more of the binder compositions described herein. For example, FIG. 12A illustrates thermal analysis results 1200 of samples from mixture 2 (comprising 60% iron powder, 20% fly ash, 8% limestone, 10% metakaolin) carbonated for 1 day, where samples were exposed to air for 3 days after carbonation. For example, plot 1205 shows thermogravimetric data for surface, and plot 1210 shows thermogravimetric data for core, with DTG plots shown as 1207, 1212 respectively.

FIG. 12B illustrates thermal analysis results 1225 of samples from mixture 2 (comprising 60% iron powder, 20% fly ash, 8% limestone, 10% metakaolin) carbonated for 2 days, where samples were exposed to air for 3 days after carbonation in accordance with some embodiments of the invention. For example, plot 1230 shows thermogravimetric data for surface, and plot 1235 shows thermogravimetric data for core, with DTG plots shown as 1232, 1237 respectively.

FIG. 12C illustrates thermal analysis results 1250 of samples from mixture 2 (comprising 60% iron powder, 20% fly ash, 8% limestone, 10% metakaolin) carbonated for 3 days, where samples were exposed to air for 3 days after carbonation. For example, plot 1255 shows thermogravimetric data for surface, and plot 1260 shows thermogravimetric data for core, with DTG plots shown as 1257, 1262 respectively.

FIG. 12D illustrates thermal analysis results 1275 of samples from mixture 2 (comprising 60% iron powder, 20% fly ash, 8% limestone, 10% metakaolin) carbonated for 4 days, where samples were exposed to air for 3 days after carbonation in accordance with some embodiments of the invention. For example, plot 1280 shows thermogravimetric data for surface, and plot 1285 shows thermogravimetric data for core, with DTG plots shown as 1282, 1287 respectively. In some embodiments, the peak at 110° C. in the thermal analysis plot (due to evaporation of water) reduces in magnitude with increases in carbonation duration (especially after 2 days of carbonation), whereas the peak at 300° C. (attributable to carbonate-oxalate cancrinite group materials) increases in magnitude significantly when the carbonation period is increased. Further, it can be observed that the difference in final weight loss between surface and core reduces as the carbonation duration is increased. In some embodiments, this indicates that CO₂ diffusion extends to the core with an increase in exposure duration as expected. After 4 days (the data shown in FIG. 12D), it can be observed that there is virtually no difference in the thermogravimetric and differential thermogravimetric signatures between the core and the surface indicating that complete carbonation can be achieved in these samples. These results are a function of specimen size, constitution, and the carbonating environment. While the thermal signatures indicate similar levels of carbonation in the core and surface of these samples, in some embodiments, the iron particles are not completely converted into iron carbonates. Moreover, as the reaction products form around these particles and the moisture content in the specimens drop, the ionic diffusion coefficient decreases and the reaction becomes extremely slow.

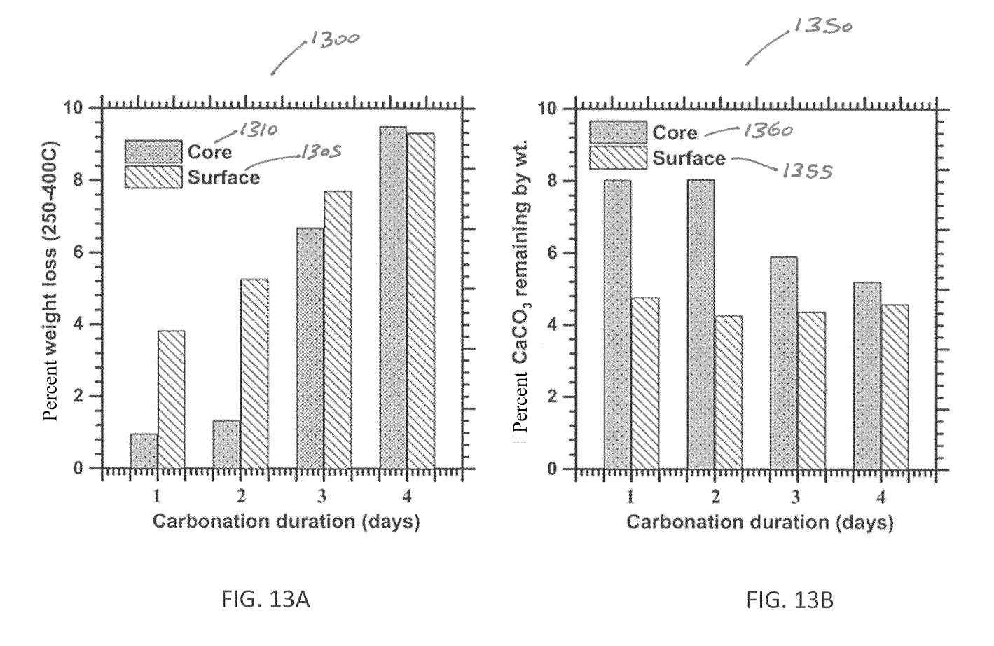

Carbonation duration-dependent mass loss patterns can be further examined in FIGS. 13A and 13B. For example, FIG. 13A illustrates a plot 1300 of the effect of carbonation duration on mass loss in the 250-400° C. range in thermogravimetric analysis with core data 1310 and surface data 1305, and FIG. 13B illustrates a plot 1350 of the effect of carbonation duration on the amount of CaCO₃ remaining in the 250-400° C. range in thermogravimetric analysis with surface data 1355 and core data 1360. In some embodiments, the carbonation degree is shown to increase with carbonation duration, with a significant increase in reaction product formation in the specimen core between 2 and 3 days of CO₂ exposure. In some embodiments, the mass loss observed in the 650-800° C. range corresponds to thermal decomposition of calcium carbonate (from the added limestone) into calcium oxide. In some embodiments, the amount of calcium carbonate remaining in the system can be calculated based on the stoichiometry of the thermal decomposition reaction of calcium carbonate. In some embodiments, the percentage of unreacted calcium carbonate present in the system for various carbonation durations (shown in FIG. 13B) illustrates a significant difference in the amount of unreacted CaCO₃ between the core and the surface in the first two days of carbonation. However, in some embodiments, this difference is reduced as the carbonation period is increased to 3 to 4 days. In some embodiments, the amount of unreacted CaCO₃ is generally the same at the specimen surface at all carbonation durations as can be observed from FIG. 13B. In some embodiments, as carbonation proceeds, the amount of CaCO₃ remaining in the core drops because of the consumption of some limestone in the reaction product formation. In some embodiments of the invention, between two and three days, there is a reduction in the amount of calcium carbonates present in the core, which corresponds to the increase in the amount of carbonate complex (shown in FIG. 13A). Thus in some embodiments, it can be inferred that some portion of calcium carbonate is utilized to form the carbonate-oxalate complex, and the remaining unreacted limestone is decomposed in that temperature range. In some embodiments, this can be evidenced by the fact that the thermal analysis study confirms a substantially similar degree of carbonation of core and surface after 4 days of carbonation, restricting the upper limit of carbonation duration to 4 days.

As evidenced by the results described herein, in some embodiments, the compressive strength of binder compositions described herein can be significantly influenced by the fly ash content. In some embodiments, while limestone in the chosen range did not influence the strength at lower fly ash contents, synergistic effects were evident at higher fly ash contents. Further, in some embodiments, metakaolin primarily influenced the processing of the binder by providing cohesion to the mixtures, and generally improving the process rheology. Moreover, in some embodiments, CO₂ exposure duration and air curing duration were also found to be influential on the mechanical properties of the one or more binder compositions. In some embodiments, the effect of air exposure time on compressive strength was found to be negligible at lower levels of carbonation (1-2 days), although the sensitivity increased significantly at higher carbonation durations (3-4 days). Thermo-gravimetric analysis showed that in some embodiments, the carbonation efficiency of iron carbonate binders is very sensitive to the overall starting material composition. Further, in some embodiments, the difference in mass loss between surface and core reduced significantly as the CO₂ diffusion is extended to the core with an increase in carbonation duration. In some embodiments, the distinct differential thermogravimetric analysis peak at 300° C., common for carbonate-oxalate cancrinite group materials, was evident in the signals from one or more of the disclosed binder compositions. Further, in some embodiments, the mass loss in the temperature range of 250-400° C. increased as the carbonation duration increased, indicating the formation of more carbonate-bearing binding products. Further, in some embodiments, calcium carbonate content in the specimen core decreased when the carbonation was increased, that in some embodiments, indicates the consumption of limestone in reaction product formation. Moreover, the results indicate that reaction product formation increases as the carbonation progresses, which in some embodiments, can result in a denser structure that can possess improved mechanical properties.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of producing iron carbonate binder compositions comprising:
providing a plurality of binder precursors,
the plurality of binder precursors including a powdered iron or steel, a first powdered additive comprising silica, a second powdered additive comprising calcium carbonate, and a powdered clay;
providing a curing chamber including a first fluid coupling between a first end of the curing chamber and a first end of a CO₂ source and a second fluid coupling between a second end of the curing chamber and a second end of the CO₂ source;
mixing the plurality of binder precursors and a water additive to form an uncured product;
feeding at least a portion of the uncured product into a curing chamber; and
using CO₂ at least partially from the CO₂ source, curing at least a portion of the uncured product to form a cured iron carbonate containing product and at least one reaction byproduct.

2. The method of claim 1, wherein the first powdered additive further comprises alumina.

3. The method of claim 1, wherein the powdered clay comprises at least one of kaolinite and metakaolin.

4. The method of claim 1, wherein the water additive comprises at least one of effluent water and seawater.

5. The method of claim 1, wherein the plurality of binder precursors includes at least one organic reducing agent comprising at least one carboxylic acid additive.

6. The method of claim 5, wherein the at least one carboxylic acid additive comprises oxalic acid.

7. The method of claim 1, wherein the second powdered additive comprises limestone.

8. The method of claim 1, wherein the first powdered additive is derived from fly ash.

9. The method of claim 1, wherein the powdered iron or steel comprises powdered iron or steel recycled from at least one industrial process.

10. The method of claim 1, wherein the curing chamber is coupled to or integrated with an existing industrial process comprising the CO₂ source.

11. The method claim 10, wherein the CO₂ source comprises a furnace of the existing industrial process.

12. The method of claim 1, wherein the CO₂ source comprises at least one of a furnace, a boiler, a reactor or process vessel, a power station or generator, an oil or gas well or field, a natural or synthetic CO₂ aquifer, a CO₂ sequestration apparatus, and the atmosphere or environment.

13. The method of claim 1, wherein CO₂ from the CO₂ source is fed to the curing chamber by the second fluid coupling.

14. The method of claim 13, wherein a flow rate of the CO₂ is determined by at least one meter and is controlled by at least one valve.

15. The method of claim 1, wherein the at least one reaction byproduct is fed from the curing chamber to the CO₂ source by the first fluid coupling.

16. The method of claim 15, wherein the at least one reaction byproduct is hydrogen gas.

17. The method of claim 15, wherein the at least one reaction byproduct is CHxOy, where x=0-4 and y=0-2.

18. The method of claim 15, wherein a flow rate of the at least one byproduct is determined by at least one meter and is controlled by at least one valve.

19. The method of claim 1, wherein at least some of the carbonate of the iron carbonate containing product is formed from CO₂ from the CO₂ source.

20. The method of claim 1, wherein the CO₂ from the CO₂ source is produced by an exothermic reaction driven at least in part by the at least one reaction byproduct.
